(19) United States
(12) Patent Application Publication
(10) Pub. No.: US 2026/0105903 A1
(43) Pub. Date: Apr. 16, 2026

(54) METABARRIER FOR SOUND MITIGATION

(71) Applicant: Temple University-Of The Commonwealth System of Higher Education, Philadelphia, PA (US)

(72) Inventors: HAIJUN Liu, Garnet Valley, PA (US); SUBHRODEEP SUSHANTA RAY, Philadelphia, PA (US)

(21) Appl. No.: 19/116,489

(22) PCT Filed: Oct. 31, 2023
(86) PCT No.: PCT/US2023/036537

§ 371 Date: Mar. 28, 2025

Related U.S. Application Data
(60) Provisional application No. 63/381,660, filed on Oct. 31, 2022.

(51) Int. Cl. G10K 11/16

(52) U.S. Cl. CPC G10K 11/16

(57) ABSTRACT

A sound barrier device is described. The device includes a first panel having a plurality of perforations, a second panel with no perforations, and a connector connecting the first and second panels and forming an air gap between the first and second panels.

### CROSS-REFERENCE TO RELATED APPLICATION

This application claims the benefit of priority to U.S. Provisional Application No. 63/381,660, filed Oct. 31, 2022, entitled: “Metabarrier for sound mitigation,” the contents of which are incorporated herein by reference as if set forth in its entirety.

### BACKGROUND OF THE INVENTION

Pickleball is a paddle sport played on a badminton-sized court with a wooden or graphite paddle and a plastic ball, and has become one of the fastest growing sports in the US and many other countries. It is extremely popular among senior citizens and retired people because it is easy to learn, low-impact, affordable, fun, and a social sport. However, it is not fun for the residents living near the pickleball court, who may hear a popping noise all day long every time the paddle hits the pickleball. In urban environments, this often leads to increased tension between the pickleball players who just want to play the sport and the residents who just want to live a peaceful life.

There are several ways to mitigate the noisy pickleball sound. One is to use quieter balls, which are not considered “real” pickleballs as they are not approved by USA Pickleball Association, and they tend to wear out very quickly. The second solution is to use quieter paddles. However, they are usually very expensive. Note that the first two solutions reduce the affordability of the sport as they increase the cost for the players, and also raises the question of enforcing such rules. The third solution is to install sound barriers on the court fence to reduce neighborhood nuisance. For the third solution, there are commercial products that include ⅛″, 6′×30′ heavy mineral filled rubber panels. However, the installation of these products makes the field very “echoey”, which is disliked by the players for this mostly outdoor sport. Another type of sound barrier is a wall blanket made of fiberglass that absorbs sound, available in 1″, 2″ and 4″ thicknesses. However, high sound absorption can only be achieved with thicker blankets, making the required blankets more expensive.

Thus, there is a need in the art for an affordable sound mitigation device. The present invention meets this need.

### SUMMARY OF THE INVENTION

A sound barrier device is described. The device includes a first panel having a plurality of perforations, a second panel with no perforations, and an air gap between the first and second panels. In some embodiments, the two panels are attached to one or more frames to create the air gap. In some embodiments, spacers are placed between the panels to create the air gap. In some embodiments, the sidewalls are added to enclose the air gap. In some embodiments, the plurality of perforations are the only openings into the enclosed air pocket. In some embodiments, the perforations each have a diameter of 1 mm. In some embodiments, the first panel has a perforation ratio of 1-3%. In some embodiments, the air gap or air pocket has a thickness of 3 mm. In some embodiments, the first panel has a thickness of 3 mm. In some embodiments, the total thickness of the first panel, the second panel and the air pocket is less than 16 mm. In some embodiments, the device is configured to absorb at least 50% of sound frequencies between 900 and 1400 Hz. In some embodiments, the device is configured to absorb at least 70% of sound frequencies between 900 and 1200 Hz. In some embodiments, the device is configured to absorb at least 90% of sound frequencies between 1000 and 1100 Hz. In some embodiments, the device is configured to absorb at least 50% of sound frequencies between 900 and 1400 Hz. In some embodiments, the device has an acoustic absorption coefficient of at least 0.5 for frequencies between 900 and 1400 Hz. In some embodiments, the device has an acoustic absorption coefficient of at least 0.7 for frequencies between 900 and 1200 Hz. In some embodiments, the device has an acoustic absorption coefficient of at least 0.9 for frequencies between 1000 and 1100 Hz. In some embodiments, the device has an acoustic reflection coefficient of less than 0.4 for frequencies between 900 and 1400 Hz. In some embodiments, the device has an acoustic reflection coefficient of less than 0.25 for frequencies between 900 and 1200 Hz. In some embodiments, the device has an acoustic reflection coefficient of less than 0.15 for frequencies between 1000 and 1100 Hz. In some embodiments, the device has an acoustic transmission coefficient of less than 0.25 for frequencies between 900 and 1400 Hz. In some embodiments, the device has an acoustic transmission coefficient of less than 0.1 for frequencies between 900 and 1200 Hz. In some embodiments, the device has an acoustic transmission coefficient of less than 0.08 for frequencies between 1000 and 1100 Hz.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIGS. 1A-1B show an exemplary sound barrier or sound mitigation device.

FIGS. 2A-2F show an exemplary scaled up device having a frame and multiple panels.

FIGS. 3A-3C show measured sound properties of sound barriers.

FIGS. 4A-4C show a comparative device and measured sound properties thereof.

FIGS. 5A-5C show another comparative device and measured sound properties thereof.

FIGS. 6A-6C show a prototype device of FIG. 1 and measured sound properties thereof.

FIGS. 7A-7C show comparative sound measurements of the devices in FIGS. 5-7.

FIGS. 8A-8C show the tunability of the device by changing the perforation ratio.

FIGS. 9A-9C show the tunability of the device by changing the airgap length or thickness.

### DETAILED DESCRIPTION

It is to be understood that the figures and descriptions of the present invention have been simplified to illustrate elements that are relevant for a clear understanding of the present invention, while eliminating, for the purpose of clarity many other elements found in related systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined elsewhere, all technical and scientific terms used herein have the same meaning as commonly understood by one of ordinary skill in the art to which this invention belongs. Although any methods and materials similar or equivalent to those described herein can be used in the practice or testing of the present invention, exemplary methods and materials are described. As used herein, each of the following terms has the meaning associated with it in this section.

Reference throughout the specification to “one embodiment”, “an embodiment” or “some embodiments” means that a particular feature, structure, or characteristic described in connection with an embodiment is included in at least one embodiment of the subject matter disclosed. Thus, the appearance of the phrases “in one embodiment”, “in an embodiment” or “in some embodiments” in various places throughout the specification is not necessarily referring to the same embodiment. Further, the particular features, structures or characteristics of “one embodiment”, “an embodiment” or “some embodiments” may be combined in any suitable manner with each other to form additional embodiments of such combinations. Further, it is intended that embodiments of the disclosed subject matter cover modifications and variations thereof.

As used in the specification and the appended claims, the singular forms “a,” “an,” and “the” include plural referents unless the context expressly dictates otherwise. That is, unless expressly specified otherwise, as used herein the words “a,” “an,” “the,” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein merely describe points of reference and do not necessarily limit embodiments of the present disclosure to any particular orientation or configuration. Furthermore, terms such as “first,” “second,” “third,” etc., merely identify one of a number of portions, components, steps, operations, functions, and/or points of reference as disclosed herein, and likewise do not necessarily limit embodiments of the present disclosure to any particular configuration or orientation.

“About” as used herein when referring to a measurable value such as an amount, a temporal duration, and the like, is meant to encompass variations of ±20%, ±10%, +5%, ±1%, and ±0.1% from the specified value, as such variations are appropriate.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6, and any whole and partial increments there between. This applies regardless of the breadth of the range.

Presented herein are devices and systems for reducing or mitigating sound, with particular application to court games such as pickleball. As opposed to current solutions that reflect sound back into the court, aspects of the present invention relate to a new type of thin sound barrier that can absorb most of the pickleball sound while maintaining a low sound transmission. In some aspects, the devices and systems may take the form of a panel or set of panels and constructed as a metabarrier that can significantly reduce the pickleball sound, which centers around ˜1 kHz based on field measurements. In some embodiments, the devices and systems target the specific narrow frequency range of pickleball sounds. Prototype testing has shown that the disclosed panels or devices (e.g., a metabarrier) can absorb more than 90% of sound in a target frequency range. The bandwidth of the targeted noise can be wider at a reduced absorption level.

The devices and systems described herein are advantageous in that they demonstrate low sound transmission and high sound absorption while maintaining a low thickness (e.g. <˜20 mm). In some embodiments, the devices and systems may be constructed from long-lasting plastics that may optionally be transparent if desired.

While embodiments described herein relate to applications for court games such as pickleball, it should be appreciated that the devices and systems described herein may be suitable for use both indoors and outdoors, and for any application where the mitigation of sound is desired. For example, in applications relating to architectural acoustics the panels may be used to control and enhance acoustics in architectural spaces such as theaters, auditoriums, concert halls, and offices to reduce noise and echoes. For applications relating to the automotive industry, the panels may be used in vehicle interiors to reduce road and engine noise, creating a quieter and more comfortable driving experience. For applications relating to the aerospace industry, the panels may be employed in aircraft cabins and cockpits to control noise levels, ensuring a quieter environment for passengers and crew. For applications relating to industrial settings, the panels may be used in industrial facilities to reduce noise pollution, improve working conditions, and meet regulatory noise control requirements. For applications relating to entertainment and studios, the panels may be utilized in recording studios, home theaters, and entertainment venues to optimize sound quality and reduce reflections and reverberations. For applications relating to the construction industry, the panels may be integrated into building materials to create sound-absorbing walls, ceilings, and facades, improving acoustic comfort in residential and commercial spaces. For applications relating to marine and naval engineering, the panels may be used in the marine industry to control noise in ships and offshore structures, ensuring a quieter and more comfortable environment for crew and passengers.

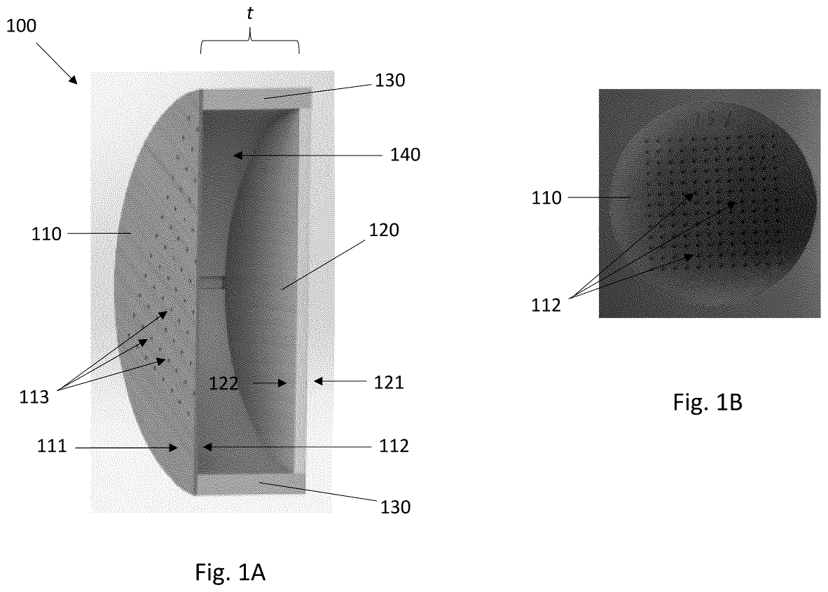

Referring now to FIGS. 1A and 1B a sound mitigation or sound barrier device or panel 100 is shown. In some embodiments, device 100 includes a first panel 110, a second panel 120, a connector 130 connected to and separating first and second panels 110 and 120 to form an air gap or air pocket 140 between first and second panels 110 and 120. Device 100 may be any shape (when front facing first panel 110 or back facing second panel 120), including square, rectangular, triangular, trapezoidal, pentagonal, hexagonal, circular, oval, random, irregular, and the like. In some embodiments, device 100, including first panel 110, second panel 120, connector 130 and air gap 140, has a total thickness of equal to or less than 50 mm, equal to or less than 45 mm, equal to or less than 40 mm, equal to or less than 35 mm, equal to or less than 30 mm, equal to or less than 25 mm, equal to or less than 20 mm, equal to or less than 18 mm, equal to or less than 16 mm, equal to or less than 14 mm, equal to or less than 12 mm, or equal to or less than 10 mm.

First panel 110 may be flat or planar, or in some embodiments first panel 110 may be curved, such as having a concave or convex shape. In some embodiments, first panel 110 is rigid. In some embodiments, first panel 110 is flexible and/or elastic. In some embodiments, a first region of first panel 110 is rigid and a second region of first panel 110 is flexible and/or elastic. In some embodiments, first panel 110 has a thickness of between 1-10 mm. In some embodiments, first panel 110 has a thickness of about 1 mm, about 2 mm, about 3 mm, about 4 mm, about 5 mm, about 6 mm, about 7 mm, about 8 mm, about 9 mm or about 10 mm. First panel 110 may have an outer surface 111 and an opposing inner surface 112. In some embodiments, outer surface 111 may be smooth, and in other embodiments outer surface 111 may be textured. For example, outer surface 111 may include one or more grooves, ridges, indentations, protrusions, and the like. In some embodiments, inner surface 112 may be smooth, and in other embodiments inner surface 112 may be textured. For example, inner surface 112 may include one or more grooves, ridges, indentations, protrusions, and the like.

First panel 110 may include one or more perforations 113 passing through the thickness of first panel 110. In some embodiments, first panel 110 includes a single perforation 113. In some embodiments, first panel 110 includes a plurality of perforations 113. Perforations 113 may be randomly positioned on first panel 110 or they may form one or more sets of perforations. For example, in some embodiments perforations 113 may be positioned in a grid or grid-like pattern. In some embodiments, at least one set of perforations 113 are linear. In some embodiments, at least one set of perforations 113 include individual perforations that are equally spaced apart. In some embodiments, the pattern of perforations 113 cover the entire outer surface 111 of first panel 110. In some embodiments, the pattern of perforations covers at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, or at least 95% of the surface area (e.g. outer and/or inner surface 111, 112) of panel 110. In some embodiments, the perforation ratio, or the total surface area (e.g. outer and/or inner surface 111, 112) of panel 110 may be perforated via perforations 113 by at least 1%, at least 2%, at least 3%, at least 4%, at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, or at least 95%. In some embodiments, the perforation ratio is between 1-3%. In some embodiments, the perforation ratio is about 1%, about 1.2%, about 1.4%, about 1.6%, about 1.8%, about 2%, about 2.2%, about 2.4%, about 2.6%, about 2.8%, or about 3%.

In some embodiments, perforations 113 may be microperforations. In some embodiments, perforations 113 may be nanoperforations. In some embodiments, the average diameter of one or more perforations may be between 0.1-2 mm. In some embodiments, the average diameter of one or more perforations is about 0.1 mm, about 0.2 mm, about 0.3 mm, about 0.4 mm, about 0.5 mm, about 0.6 mm, about 0.7 mm, about 0.8 mm, about 0.9 mm, about 1 mm, about 1.1 mm, about 1.2 mm, about 1.3 mm, about 1.4 mm, about 1.5 mm, about 1.6 mm, about 1.7 mm, about 1.8 mm, about 1.9 mm, or about 2 mm. In some embodiments, the diameter of each perforation 113 is the same or uniform. In some embodiments, the diameter of each perforation 113 is variable or random. In some embodiments, the diameter of each perforation in at least one set of perforations 113 is the same or uniform. In some embodiments, the diameter of each perforation in at least one set of perforations 113 is variable or random. In some embodiments, the diameter of each perforation in a first set of perforations 113 is the same or uniform, and the diameter of each perforation in a second set of perforations 113 is variable or random.

Perforations 113 may be any geometry or shape. In some embodiments, perforations 113 may be circular, oval, oblong, slits, star shaped, square, rectangular, triangular, trapezoidal, pentagonal, hexagonal, random, irregular, and any combination thereof. In some embodiments, the sidewalls of perforations 113 through the thickness of first panel 110 may be parallel to each other, and perpendicular to outer surface 111 and/or inner surface 112. In some embodiments, the sidewalls of perforations 113 through the thickness of first panel 110 may be at an angle relative to outer surface 111 and/or inner surface 112, such as an angle between 5-85°, or of about 85°, about 80°, about 75°, about 70°, about 65°, about 60°, about 55°, about 50°, about 45°, about 40°, about 35°, about 30°, about 25°, about 20°, about 15°, about 10°, or about 5°. Accordingly, the shape of perforations 113 passing through the thickness of first panel 110 may be any shape, including rectangular, cylindrical, conical, trapezoidal, star shaped, and the like. Further still, the diameter of a perforation 113 on the outer surface 111 of first panel 110 may be equal to, larger, or smaller than the diameter of the same perforation on the inner surface 112.

As contemplated herein, a spring-mass system can be used as an equivalent mechanical system for better understanding. The air trapped in the perforations acts as a mass, and the air gap between panels acts as a spring. Accordingly, by changing the shape, size, and number of the perforations and the width of the air gap, the performance of device 100 may be tuned. Further, by considering the thermoviscous losses, the performance may be tuned. The edge geometry of the perforations can influence these losses thus influencing the performance of the device.

Second panel 120 may be flat or planar, or in some embodiments second panel 120 may be curved, such as having a concave or convex shape. In some embodiments, second panel 120 is rigid. In some embodiments, second panel 120 is flexible and/or elastic. In some embodiments, a first region of second panel 120 is rigid and a second region of second panel 120 is flexible and/or elastic. In some embodiments, second panel 120 has a thickness of between 1-10 mm. In some embodiments, second panel 120 has a thickness of about 1 mm, about 2 mm, about 3 mm, about 4 mm, about 5 mm, about 6 mm, about 7 mm, about 8 mm, about 9 mm or about 10 mm. Second panel 120 may have an outer surface 121 and an opposing inner surface 122. In some embodiments, outer surface 121 may be smooth, and in other embodiments outer surface 121 may be textured. For example, outer surface 121 may include one or more grooves, ridges, indentations, protrusions, and the like. In some embodiments, inner surface 122 may be smooth, and in other embodiments inner surface 122 may be textured. For example, inner surface 122 may include one or more grooves, ridges, indentations, protrusions, and the like. In some embodiments, second panel 120 is solid with no perforations. In some embodiments, second panel 120 has one or more perforations. In some embodiments, second panel 120 may include any perforations or perforation profile as described for perforations 113 of first panel 110.

As explained previously, connector 130 separates first and second panels 110 and 120 to form an air gap or air pocket 140 between first and second panels 110 and 120. Accordingly, the width of connector 130 determines the thickness t of air gap 140 of device 100. In some embodiments, the width of connector 130 may be between 3-60 mm. In some embodiments, the width of connector 130 is about 3 mm, about 4 mm, about 5 mm, about 6 mm, about 7 mm, about 8 mm, about 9 mm, about 10 mm, about 15 mm, about 20 mm, about 25 mm, about 30 mm, about 35 mm, about 40 mm, about 45 mm, about 50 mm, about 55 mm, or about 60 mm. In some embodiments, the width of connector 130 is equal around the perimeter of device 100. In some embodiments, the width of connector 130 is variable around the perimeter of device 100. In some embodiments, connector 130 is peg, a rod or a pin. In some embodiments, connector 130 is a spacer. In some embodiments, connector 130 is a sidewall. In some embodiments, connector 130 is a frame. In some embodiments, connector 130 is solid or continuous around the perimeter of device 100. In some embodiments, connector 130 is segmented around the perimeter of device 100. As explained previously, connector 130 may be any shape, and in some embodiments forms the shape of device 100 (e.g., square, rectangular, triangular, trapezoidal, pentagonal, hexagonal, circular, oval, random, irregular, and the like). In some embodiments, connector 130 may be a frame or frame set to which one or more first and second panel sets can be affixed. As contemplated herein, connector 130 may serve as a connecting material and in some embodiments, may form a seal with first panel 110, second panel 120, or both. In some embodiments, the width of connector 130 is independent of the thickness t of air gap 140. For example, one or both of panels 110 and 120 may be inset within the perimeter formed by connector 100, thereby creating a connector having a width that is greater than the thickness of air gap 140.

First panel 110, second panel 120 and connector 130 may each be constructed from a variety of materials, depending on user application. Exemplary materials for each component include metals (e.g., aluminum or stainless steel), wood, carbon fiber, plastics, rubber, cloth, fabrics and the like. Plastics such as polycarbonate and acrylic may be used if transparency of the material is desired.

Air gap or air pocket 140 is the space within the enclosure formed by first panel 110, second panel 120 and connector 130. Accordingly, air gap 140 may also be referred to herein as enclosure 140. In some embodiments, perforations 130 are the only opening into air gap or enclosure 140. The thickness t of air gap 140 may be between 1-60 mm. In some embodiments, the thickness t of air gap 140 may be between 5-50 mm. In some embodiments, the thickness t of air gap 140 may be about 1 mm, about 2 mm, about 3 mm, about 4 mm, about 5 mm, about 6 mm, about 7 mm, about 8 mm, about 9 mm, about 10 mm, about 12 mm, about 14 mm, about 16 mm, about 18 mm, about 20 mm, about 25 mm, about 30 mm, about 35 mm, about 40 mm, about 45 mm, about 50 mm, about 55 mm, or about 60 mm. In some embodiments, the thickness t of air gap 140 is equal through device 100. In some embodiments, the thickness t of air gap 140 is variable through device 100. In some embodiments, device 100 may include one or more partitions or internal walls (not shown) within enclosure 140 connected to first panel 110 and second panel 120, and optionally connected to connector 130, thereby creating a plurality of air gap regions or segments within enclosure 140. In some embodiments, the partitions are solid. In some embodiments, the partitions include one or more transverse openings or perforations. In some embodiments, the partitions are rigid. In some embodiments, the partitions may be flexible or elastic.

In some embodiments, the air between first panel 110 and second panel 120 acts as a spring. Accordingly, the volume of air in the perforations determines the stiffness of the spring. By controlling the distance between the two panels, the absorption characteristics may be tuned. The airgap can also be designed to have different shapes to optimize the absorption characteristics such as coils and honeycomb. In some embodiments, device 100 includes a constant airgap between the two panels. The structure can be modified, so that the airgap is different at different segments of the panel.

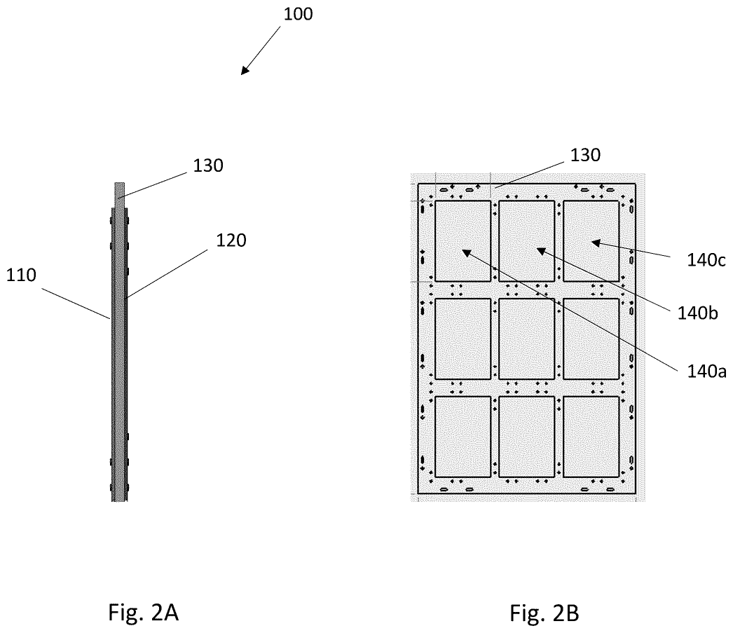

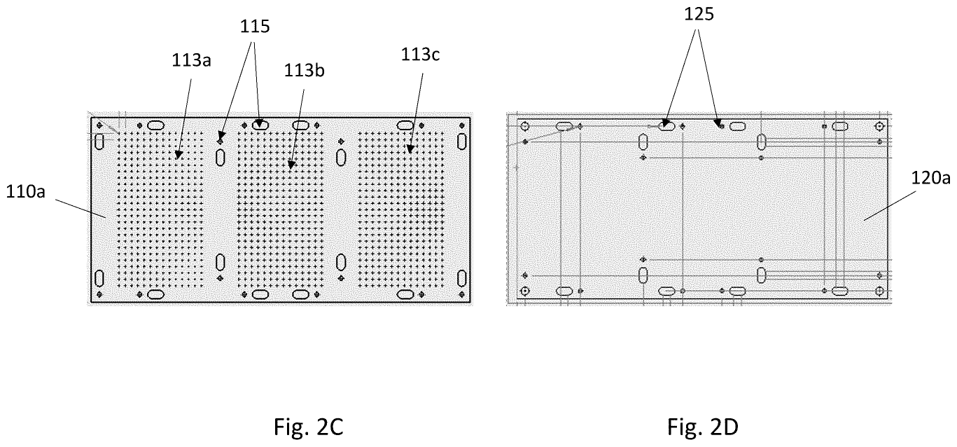

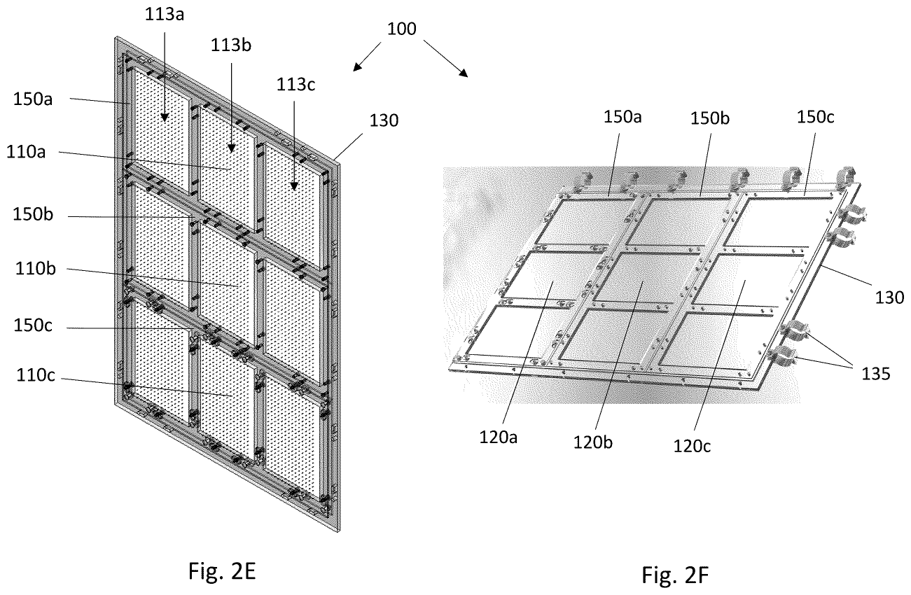

Depending on the desired application, the device may be scaled to a larger size by including multiple panels into a single-framed or multi-framed structure. For example, FIG. 2A is a top down view of device 100 which includes a connector 130 in the form of a frame (also referred to herein as frame 130), to which one or more sets of first and second panels can be attached to form one or more air gaps or enclosures. FIG. 2B shows a front view of frame 130 with multiple openings that will form the air gaps or enclosures 140 (e.g., 140a, 140b and 140c) when the first and second panels are subsequently attached.

FIGS. 2C and 2D show the first panel 110a and 120a, respectively, of a first and second panel set. First panel 110a includes multiple sets of perforations (e.g., 113a, 113b and 113c), while corresponding second panel 120a has a solid backing with no perforations. First panel 110a may include one or more regions or openings 115 for fasteners (e.g., screws, rivets, etc.) to engage and attach first panel 110a to frame 130. Likewise, second panel 120a may include one or more regions or openings 125 for fasteners to engage and attach second panel 120a to frame 130. FIGS. 2E and 2F show a front and back perspective view, respectively, of device 100 forming a nine sound barrier panel assembly utilizing three sets of first and second panels. First panels 110a, 110b and 110c are attached to the front face of frame 130, while corresponding second panels 120a, 120b and 120c are attached to the back face of frame 130. Alternatively, exterior frames 150a, 150b and 150c can also be used to engage and attach to frame 130 with the first and second panels sandwiched between frame 130 and exterior framing 150a, 150b and 150c. As shown in FIG. 2F, clamps, ties, fasteners or other engagement mechanisms 135 may be used to attach the assembly to any desired structure, such as a fencing pole.

It should be appreciated that any number of first and second panel sets may be utilized to form any number of corresponding enclosures 140 using a single connector/frame 130 structure. Accordingly, multiple sound barrier devices or panels can be arranged in any configuration depending on the size and shape of the framing used. In some embodiments, frame 130 may be flat, curved, arched, or any desired shape, such that one or more sets of first and second panels 110, 120 may conform to the overall desired shape of frame 130.

Aspects of the present invention relate to the acoustic properties of sound barrier device 100. In some embodiments, device 100 has an acoustic absorption coefficient for frequencies of between 900 and 1400 Hz of at least 0.5, at least 0.55, at least 0.6, at least 0.65, at least 0.7, at least 0.75, at least 0.8, at least 0.85, at least 0.9, or at least 0.95. In some embodiments, device 100 has an acoustic absorption coefficient for frequencies of between 900 and 1200 Hz of at least 0.65, at least 0.7, at least 0.75, at least 0.8, at least 0.85, at least 0.9, or at least 0.95. In some embodiments, device 100 has an acoustic absorption coefficient for frequencies of between 1000 and 1100 Hz of at least 0.9, at least 0.91, at least 0.92, at least 0.93, at least 0.94, at least 0.95, at least 0.96, at least 0.97, or at least 0.98. Phrased another way, the percent absorption of sound frequencies between 900 and 1400 Hz by device 100 may be at least 50%, at least 55%, at least 60%, at least 65%, at least 70%, at least 75%, at least 80%, at least 85%, at least 90%, or at least 95%. In some embodiments, the percent absorption of sound frequencies between 900 and 1200 Hz by device 100 may be at least 70%, at least 75%, at least 80%, at least 85%, at least 90%, or at least 95%. In some embodiments, the percent absorption of sound frequencies between 1000 and 1100 Hz by device 100 may be at least 90%, at least 91%, at least 92%, at least 93%, at least 94%, at least 95%, at least 96%, at least 97%, or at least 98%.

In some embodiments, device 100 has an acoustic reflection coefficient for frequencies of between 900 and 1400 Hz of less than 0.4, less than 0.35, less than 0.3, less than 0.25, less than 0.2, less than 0.15, less than 0.1, or less than 0.05. In some embodiments, device 100 has an acoustic reflection coefficient for frequencies of between 900 and 1200 Hz of less than 0.25, less than 0.2, less than 0.15, less than 0.1, or less than 0.05. In some embodiments, device 100 has an acoustic reflection coefficient for frequencies of between 1000 and 1100 Hz of less than 0.15, less than 0.1, or less than 0.05.

In some embodiments, device 100 has an acoustic transmission coefficient for frequencies of between 900 and 1400 Hz of less than 0.25, less than 0.2, less than 0.15, less than 0.1, or less than 0.05. In some embodiments, device 100 has an acoustic transmission coefficient for frequencies of between 900 and 1200 Hz of less than 0.1, less than 0.09 less than 0.08 less than 0.07 less than 0.06, or less than 0.05. In some embodiments, device 100 has an acoustic transmission coefficient for frequencies of between 1000 and 1100 Hz of less than 0.08 less than 0.07 less than 0.06, or less than 0.05.

### EXPERIMENTAL EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skills in the art can, using the preceding description and the following illustrative examples, make and utilize the present invention and practice the claimed methods. The following working examples therefore are not to be construed as limiting in any way the remainder of the disclosure.

Sound absorption is key to speech intelligibility, speech privacy, and reducing distraction distance. However, to achieve superb sound absorbing performance, panels made of traditional materials are too thick for low-frequency sound such as air conditioning and traffic noise. On the other hand, thin panels created with the current acoustic metamaterials are limited to a very narrow bandwidth that is not suitable for practical use. The proposed project aims to address the fundamental bandwidth limitation in acoustic metamaterials so that novel thin panels can be developed with broadband sound absorption performance.

### Example 1: Acoustic Barrier for Pickleball Sound Mitigation

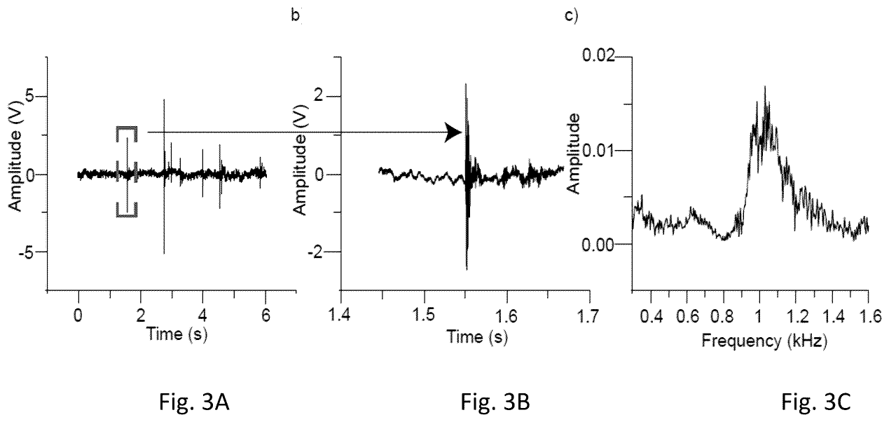

In search for the ideal sound barrier, a visit was made to the Water Tower pickleball court to record the sound. Although the SPL (sound pressure level) was on average below 70 dB on a relatively busy day, a person can feel the nuisance for the residents who live about 10 ft away from the pickleball court. Each time a paddle hits the pickleball, there will be a popping noise, shown as a spike in the recorded sound signal (FIGS. 3A and 3B). However, the spectrum plot shows that the pickleball sound shows a narrow band around ˜1 kHz (FIG. 3C), which makes it a perfect application candidate for acoustic metamaterials.

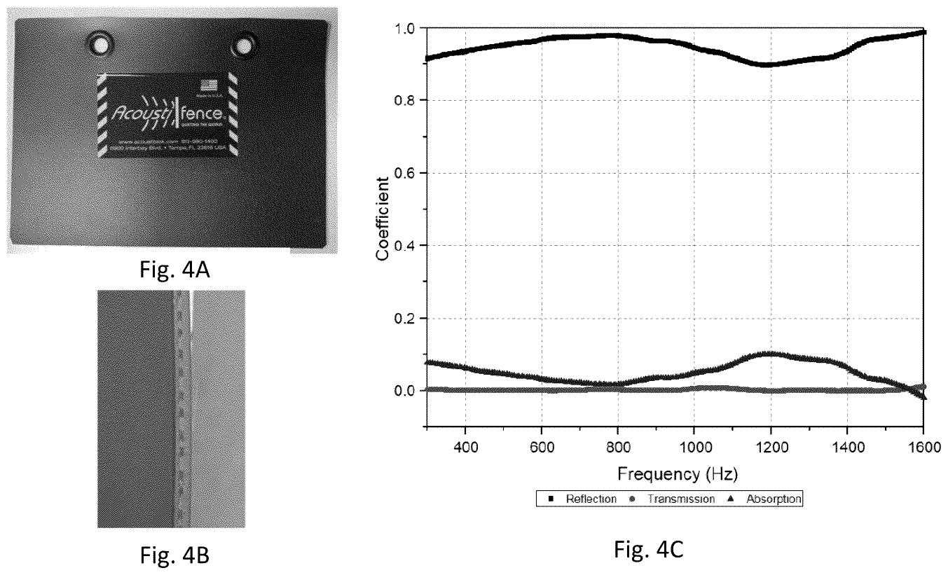

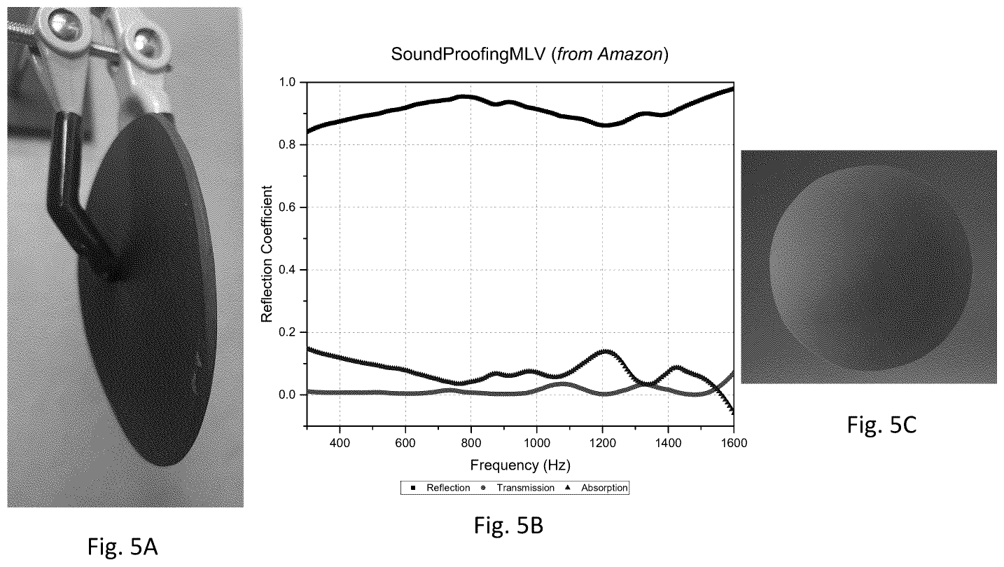

Next, the acoustic properties of the commercially available Acoustifence sound barrier was characterized. FIGS. 4A and 4B show the front and side views of the sample. As shown in FIG. 4C, the transmission coefficient is close to zero, while the reflection coefficient is close to 1, and only less than 10% of the sound is absorbed. It should be noted that these testing results are obtained using a 4″-sized sample in the impedance tube, and the transmission coefficient is expected to be larger for the much larger panel. As a comparison, a rubber sheet of the same thickness purchased from Amazon (https://www.amazon.com/gp/product/B08562TSXQ) was characterized (FIGS. 5A and 5C). The acoustic properties are essentially the same as the trademarked Acoustifence (FIG. 5B). The conclusion is that these commercially available sound barriers for pickleball sound mitigation serve primarily as sound reflectors, which is not ideal.

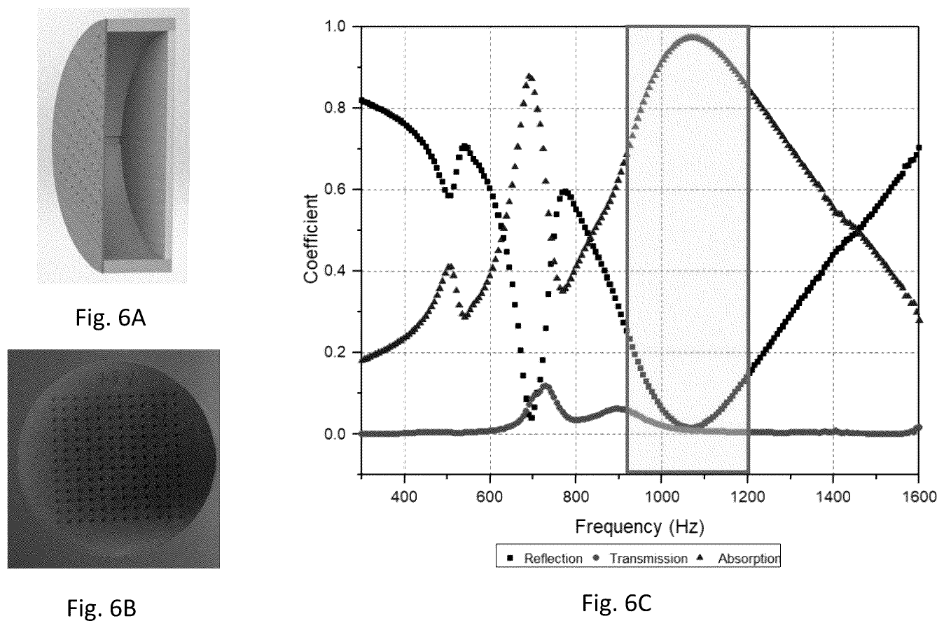

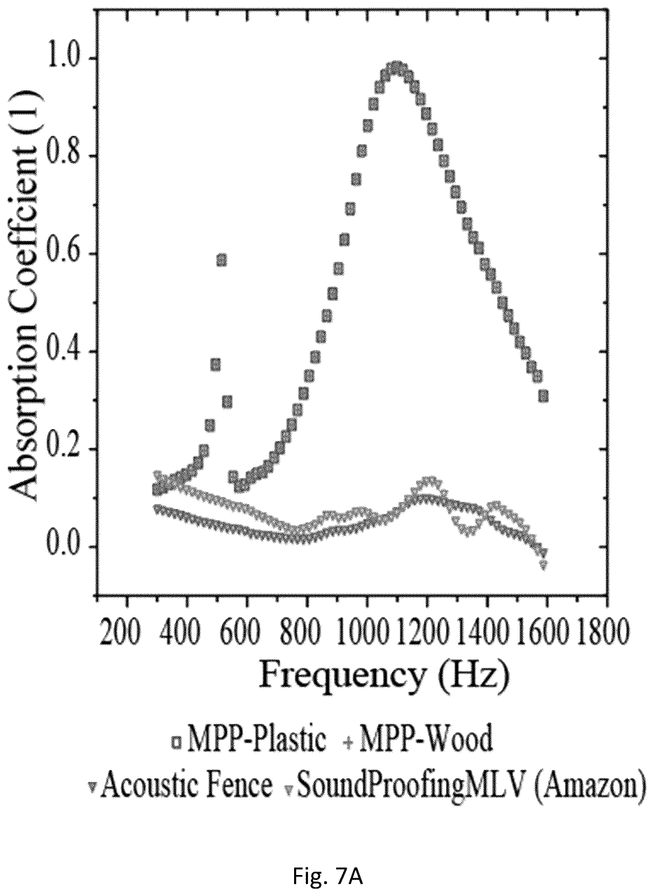

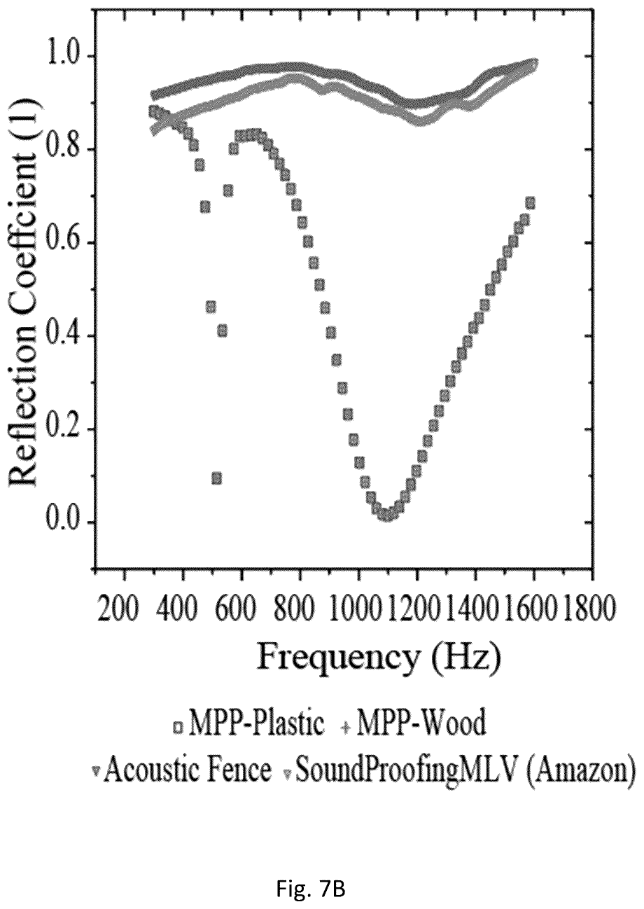

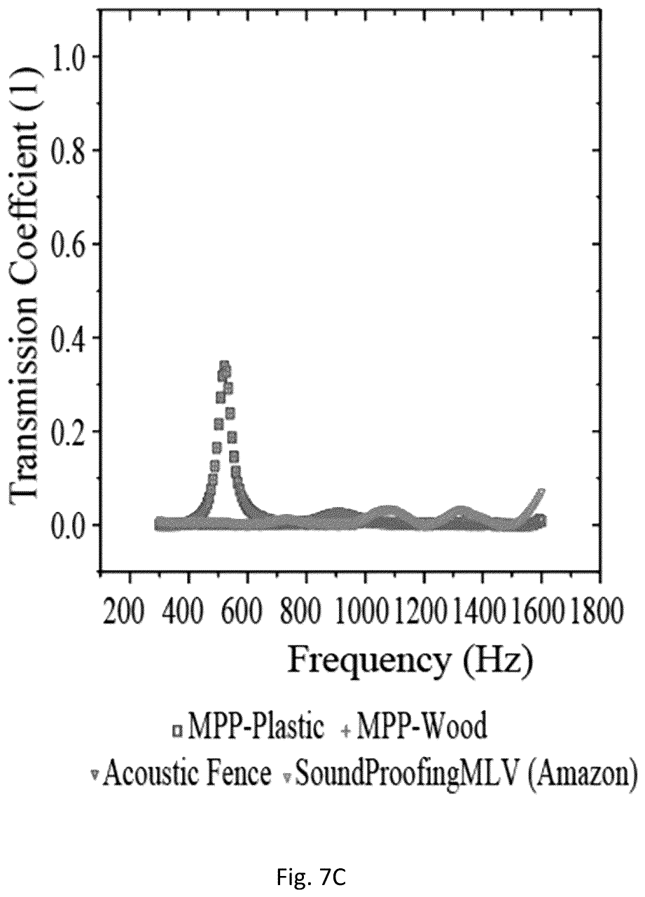

As a preliminary study, a sandwich acoustic metamaterial structure (i.e. device 100, and also referred to herein as metabarrier or MPP) was designed for pickleball sound mitigation. As shown in FIG. 6A, the design consists of three layers: a front perforated panel, a back solid panel, and an air gap in between. Several prototypes have been fabricated by laser machining 1-mm holes on a ⅛″-thick tempered hardwood with various perforation ratio (percentage of the hole area relative to the whole area or surface area), as shown in FIG. 6B. In terms of functionality of each unit cell, technically it is equivalent to a Helmholtz resonator where the air in the through-hole serves as the inertial element, while the air gap serves as the elastic/spring element. The measured results in FIG. 6C clearly indicate that this sandwich structure has the same low transmission in the frequency range of interest near 1 kHz, but more importantly, it has very high absorption (>90%), which would be the ideal sound barrier for pickleball sound mitigation. Accordingly and as shown in FIGS. 7A-7C, the device 100 design (MPP composed of either plastic or wood) shows a surprising and unexpected superior characteristics as compared to existing products on the market.

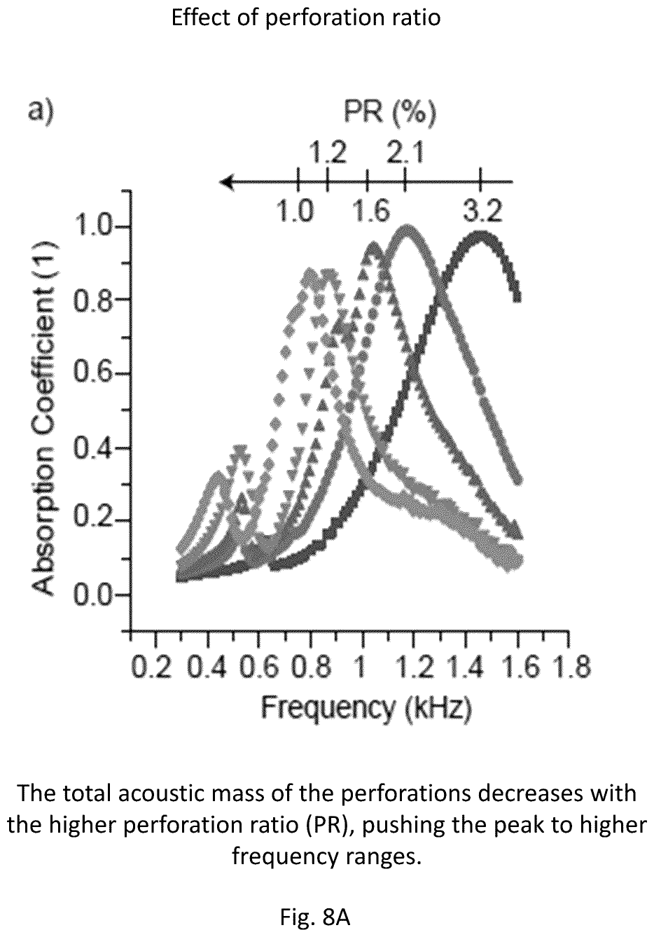

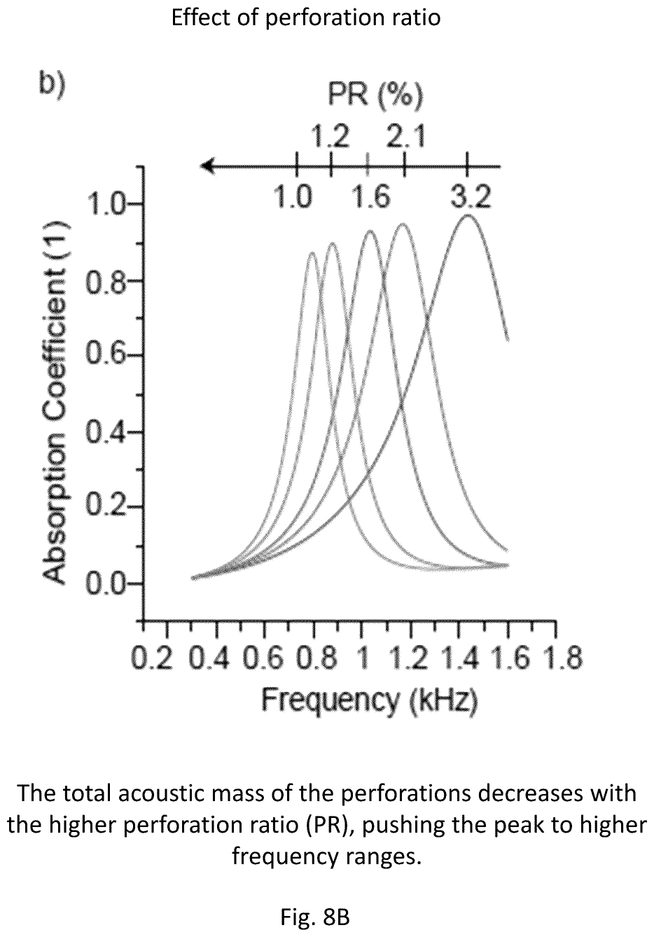

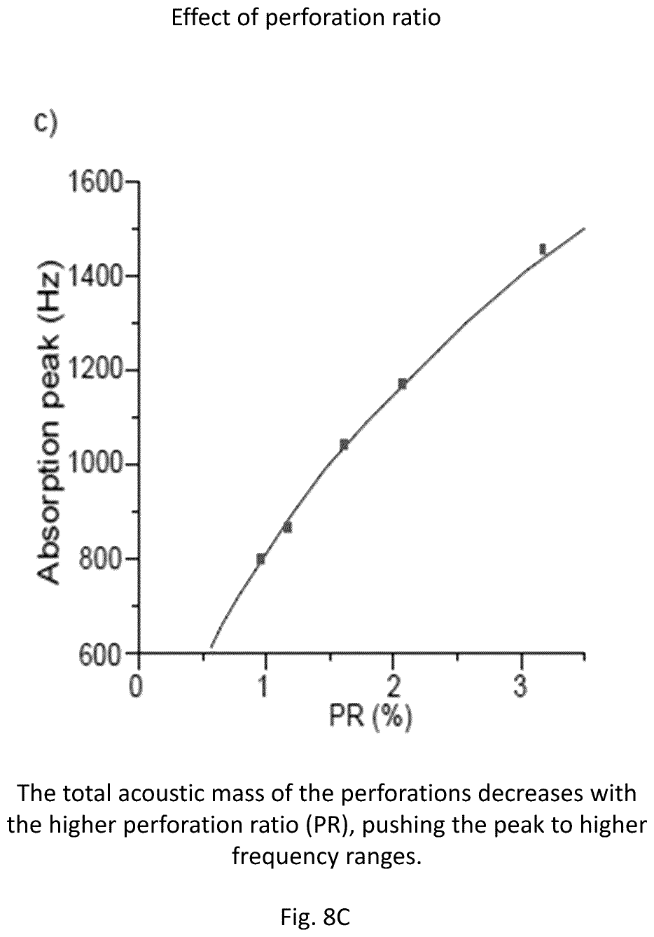

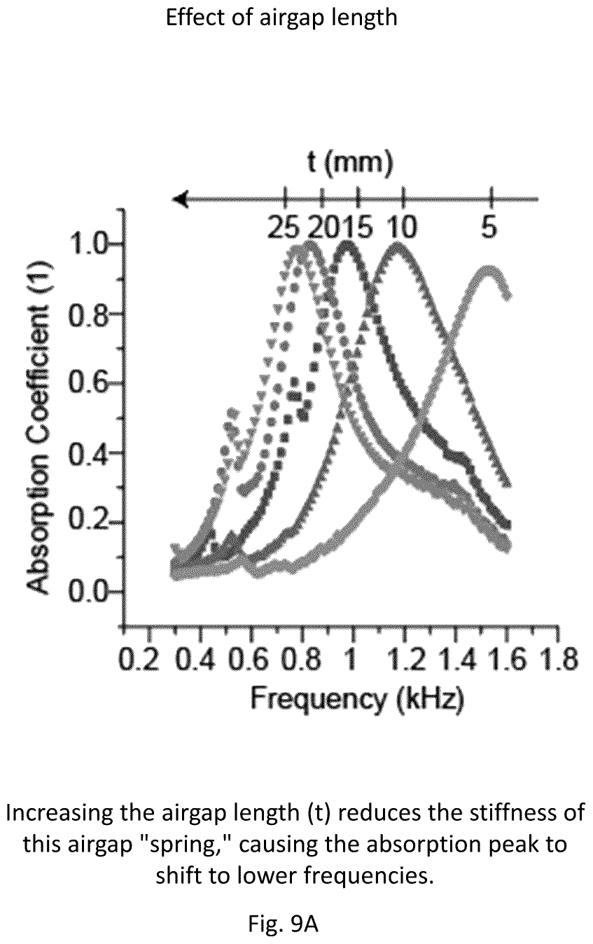

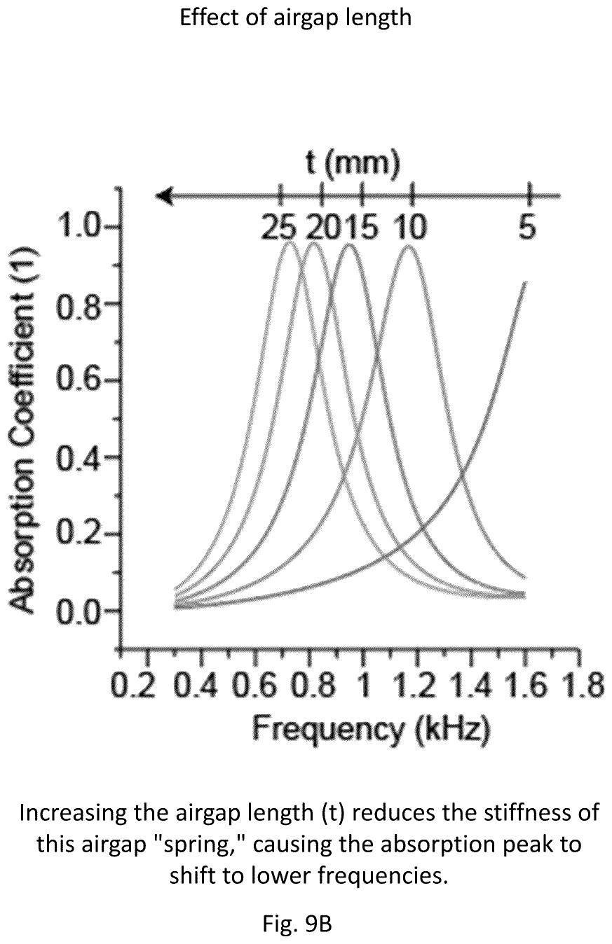

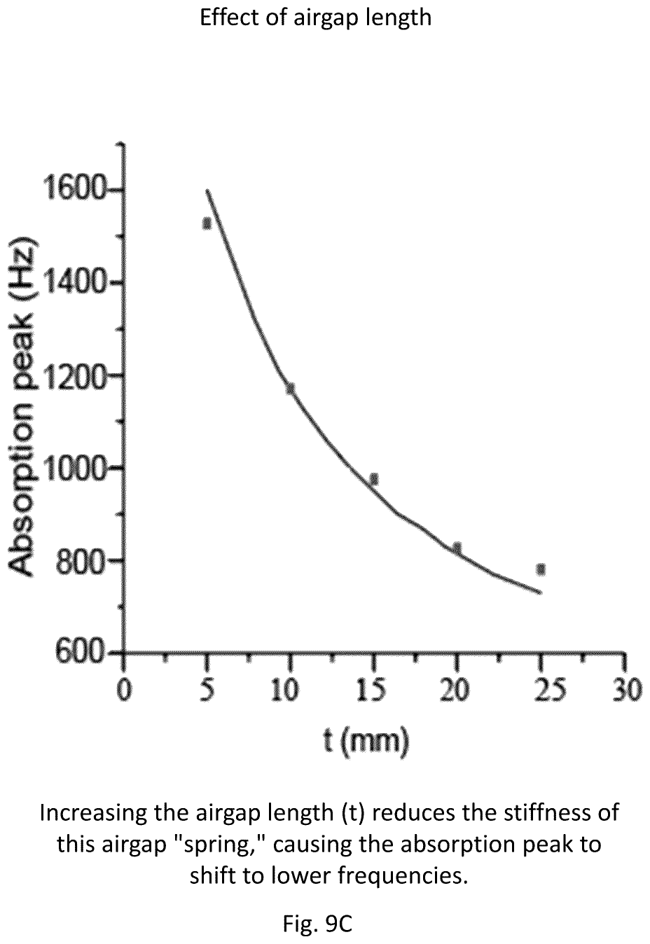

The tunability of the structure for specific frequencies is demonstrated in FIGS. 8-9. The parameters studied are perforation ratio and airgap length or thickness. As the perforation ratio increases, the absorption peak moves to higher frequency as shown in FIG. 8C. FIGS. 8A and 8B show the agreement in the experiment and simulation results. With the airgap length or thickness increasing, the frequency reduces as shown in FIG. 9C. The spectrums for the experiment and simulation are compared in FIGS. 9A and 9B.

The disclosures of each and every patent, patent application, and publication cited herein are hereby each incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

1. A sound barrier device, comprising:
a first panel having a plurality of perforations, wherein the first panel has a perforation ratio of between 1.0% to 3.2%;
a second panel with no perforations; and
a connector connecting the first and second panels and forming an air gap between the first and second panels, wherein the air gap has a thickness of between 5-25 mm.

2. The device of claim 1, wherein the connector is a spacer.

3. The device of claim 1, wherein the connector is a frame.

4. The device of claim 1, wherein the perforations each have a diameter of between 0.1-2 mm.

5. (canceled)

6. (canceled)

7. The device of claim 1, wherein the first panel has a thickness of between 1-10 mm.

8. The device of claim 1, wherein the total thickness of the first panel, the second panel and the air pocket is equal to or less than 16 mm.

9. The device of claim 1, wherein the device is configured to absorb at least 50% of sound frequencies between 900 and 1400 Hz.

10. The device of claim 1, wherein the device is configured to absorb at least 70% of sound frequencies between 900 and 1200 Hz.

11. The device of claim 1, wherein the device is configured to absorb at least 90% of sound frequencies between 1000 and 1100 Hz.

12. (canceled)

13. The device of claim 1, wherein the device has an acoustic absorption coefficient of at least 0.5 for frequencies between 900 and 1400 Hz.

14. The device of claim 1, wherein the device has an acoustic absorption coefficient of at least 0.7 for frequencies between 900 and 1200 Hz.

15. The device of claim 1, wherein the device has an acoustic absorption coefficient of at least 0.9 for frequencies between 1000 and 1100 Hz.

16. The device of claim 1, wherein the device has an acoustic reflection coefficient of less than 0.4 for frequencies between 900 and 1400 Hz.

17. The device of claim 1, wherein the device has an acoustic reflection coefficient of less than 0.25 for frequencies between 900 and 1200 Hz.

18. The device of claim 1, wherein the device has an acoustic reflection coefficient of less than 0.15 for frequencies between 1000 and 1100 Hz.

19. The device of claim 1, wherein the device has an acoustic transmission coefficient of less than 0.25 for frequencies between 900 and 1400 Hz.

20. The device of claim 1, wherein the device has an acoustic transmission coefficient of less than 0.1 for frequencies between 900 and 1200 Hz.

21. The device of claim 1, wherein the device has an acoustic transmission coefficient of less than 0.08 for frequencies between 1000 and 1100 Hz.

22. A sound barrier device, comprising:
a first panel having a plurality of perforations, wherein the first panel has a perforation ratio of between 1.2% to 2.1%, wherein each of the perforations have an average diameter greater than 0.2 mm;
a second panel with no perforations; and
a connector connecting the first and second panels and forming an air gap between the first and second panels, wherein the air gap has a thickness of between 10-20 mm;
wherein the first and second panel comprise wood or plastic;
wherein the perforation ratio, the average diameter of the perforations, and the air gap provide an absorption coefficient greater than 0.9 for frequencies between 900 to 1200 Hz.
